(19) United States
(12) Patent Application Publication
(10) Pub. No.: US 2008/0305235 A1
(43) Pub. Date: Dec. 11, 2008

(54) Whey Product and Process

(75) Inventors: Hongping Gao, Cambridge (NZ); Palatasa Havea, Palmerston North (NZ); Harjinder Singh, Palmerston North (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP, Auckland (NZ)

(21) Appl. No.: 11/722,643

(22) PCT Filed: Dec. 23, 2005
(86) PCT No.: PCT/NZ2005/000343

§ 371 Date: Jun. 4, 2008

(30) Foreign Application Priority Data
Dec. 24, 2004 (NZ) 537456

(51) Int. Cl. A23J 1/20; A23C 1/14; A23C 9/142; A23C 9/14

(52) U.S. Cl. 426/565; 426/656; 426/583

(57) ABSTRACT

The invention provides a process for preparing a dried modified whey protein concentrate. A whey protein solution is used having less than 5% total solids and a combined calcium and magnesium concentration of less than 70 mmol/kg on a dry basis and a pH of 6.0-7.5. It is heated to greater than 70° C. for up to 60 minutes to denature the whey protein. The solution is then cooled to 40° C.-60° C.; and subsequently spray dried. Alternatively a higher initial concentration of total solids may be used in an embodiment where the heating is carried out on a scraped surface heat exchanger.

### TECHNICAL FIELD

This invention relates to a whey protein concentrate comprising denatured whey proteins and capable of forming viscous solutions upon addition of hot or cold water, compared with corresponding whey protein concentrates with undenatured whey proteins.

### BACKGROUND ART

Whey protein is a by-product of the manufacture of cheese or precipitation of casein. In addition to water, whey also contains lactose, minerals, and whey proteins. Large amounts of whey are produced during the manufacturing of cheese and other dairy products. Whey protein products such as whey protein concentrate (WPC) and whey protein isolate (WPI) are manufactured by removing much of the other components leaving the whey protein as the principal component. WPCs normally have a protein content of up to 85%, whereas WPIs normally have a protein content of 90% or more. Achievement of high protein contents is made possible due to the application of established technologies such as ultrafiltration, diafiltration and ion exchange. As proteins with good nutritional value, these products are useful as food ingredients.

They are used as functional ingredients in many foods, such as processed meat, bakery and dairy products (Kinsella, J. E. & Whitehead, D. M. Proteins in whey: chemical, physical, and functional properties. Advances in Food Nutrition Research, 33, 343-438, 1989). However, commercial uses of WPCs are limited because of unpredictable variations in their functional properties, due to composition and processing inconsistencies (Xiong, Y. L., Influences of pH and ionic environment on the thermal aggregation of whey proteins. Journal of Agricultural and Food Chemistry, 40, 380-384, 1992). Whey proteins may be combined with polysaccharides for use as a gelling agent (see for example U.S. Pat. No. 6,497,915). Other hydrocolloids are used in combination with whey protein in applications where whey ingredients alone does not provide a satisfactory gelling function.

U.S. Pat. No. 6,139,900 describes a process for making whey protein dispersion with a low viscosity comparable to that of a carbohydrate hydrocolloid. The process comprises
a) providing a solution of whey proteins of at least about 2% whey proteins and having a pH of at least about 8.0;
b) heating said solution of whey proteins in a first heating step;
c) cooling said solution of whey proteins;
d) adjusting the pH of said solution of whey proteins to less than about pH 8.0; and
e) heating said whey protein solution in a second heating to produce a whey protein product.

That process has the disadvantage that an alkaline heat treatment step is used and it uses a whey protein isolate. Heating at alkaline pHs had been known to induce undesirable flavour in some of the milk products and the use of whey protein isolate makes it uneconomical to produce denatured whey protein products. This treatment does have an advantageous effect in that it results in the formation of disulphide-linked protein aggregates, which have a tendency to be stable for a long period without forming the gel.

UK patent, GB 2055846A, discloses a process for lowering the gelling temperature of whey protein. The process comprises maintaining an aqueous solution of whole whey proteins having a protein concentration of from 0.5 to 10% w/v at an elevated temperature of at least 70° C., for a period of time to allow denaturation of protein, and at a pH of 7.5 to 9.0. The same patent also discloses prior art wherein whey is heated at pH 6.0-7.5 before cooling to results in the product being good for whipping but not suitable for replacing of egg whites in food systems requiring the heat-set or coagulation property of egg whites (i.e. gelling). All the examples in this patent had whey protein heated at pH 8.0.

U.S. Pat. No. 6,451,371 B1 also disclose a similar process where whey protein solutions of 2 to 4% prepared from WPI are heated under similar conditions (pH 8.0, ≧75° C.) for a period.

U.S. Pat. No. 6,767,575 B1 discloses a process for preparing a concentrate solution of denatured whey protein aggregate having a mean particle size of between 1 and 4 μm. The process consists of an aqueous solution enriched to a maximum protein content of 4%, w/w, and a pH of 5.0 to 7.0 heated at 75-150° C. for a period to allow 80-90% of the protein to denature. The product is concentrated to a denatured whey protein concentration of between 5 and 20%. The invention uses non-enriched whey stream as a starting raw material. The heated product is used a fat replacer.

Attempts to make cold gelling WPCs have been hindered by the tendency to rapidly gel of whey protein concentrates or isolates or a whey that has been heated to denature the whey proteins. This is unsatisfactory as delay in gelation is required for a time sufficient to allow the dewatering of the whey proteins prior to spray drying. In a commercial process substantial time can pass simply in transferring the whey proteins solution out of the heating vessel. Concentration of the dilute whey protein solution is necessary as it is uneconomic to spray dry whey protein solutions at less than 5% (w/v) total solids. Gelation must be avoided during this time also if a satisfactory dried gelling WPC is to be prepared.

It is an object of the present invention to provide an improved process for preparing whey protein concentrates, that can be dried and used as a viscosity-enhancing or gelling agent.

### DISCLOSURE OF THE INVENTION

In one aspect the invention provides a process for preparing a modified whey protein concentrate comprising:
(a) providing a whey protein solution having less than 5%, preferably less than 3% protein and a combined calcium and magnesium concentration of less than 70 mmol/kg, w/w, preferably less than 60 mmol/kg, most preferably less than 50 mmol/kg, w/w, on a dry basis and a pH of 6.0-7.5, preferably 6.5-7.5;
(b) heat treating the solution obtained to greater than 70° C. for up to 60 minutes to denature the whey protein;
(c) cooling the heated solution to 40° C.-60° C. preferably 45 to 55° C.;
(d) spray drying to prepare a dried product.

Preparation of the protein solution defined in (a) may use a raw whey of less than 1% protein and a pH of approximately 4.6. By ultrafiltration, lactose and minerals are removed resulting in a retentate stream having a low levels of free cations, especially the divalent ions—calcium (Ca²⁺) and magnesium (Mg²⁺). These ions have been shown to promote the aggregation and gel formation of whey protein upon heating (Kuhn, P. R. & Foegeding, E. A., Mineral salt effects on whey protein gelation, Journal of Agricultural and Food Chemistry, 39, 1013-1016, 1990; Xiong, Y. L., Influences of pH and ionic environment on the thermal aggregation of whey proteins. Journal of Agricultural and Food Chemistry, 40, 380-384, 1992; Havea, P., Singh, H., Creamer, L. K., Heat-induced aggregation of whey proteins: comparison of cheese WPC with acid WPC and relevance of mineral composition, 50, 4674-4681, 2002). Having low concentrations of these, a protein solution may be heated but gel formation is delayed allowing further concentration and processing of the product stream. Typically the concentration step can be done either by ultrafiltration or evaporation and are carried out at about 45-55° C. The solution pH adjustment is preferably carried out using KOH or NaOH, most preferably in solution. The pH is increased to 6.0-7.5, preferably 6.5-7.5, preferably 6.5-7.3, more preferably 6.7-7.0, most preferably 6.9. Preferably the proteins are not subjected to pHs above 8, preferably not above 7.5, at any step in the process. Higher pHs are associated with adverse flavour effects.

Starting solution may be prepared by reconstitution of a WPC powder having a combined calcium and magnesium of the right levels as defined in (a) above. The solution is then heated to denature the whey protein prior to further concentration.

Typically a whey protein concentrate comprising at least 10% (w/v) total solids is prepared by ultrafiltration and then diluted prior to the heating step. Particularly preferred for this ultrafiltration are low pHs, preferably pH 4-6, more preferably 4-5, most preferably pH 4.6.

In alternative embodiments other methods of calcium removal may be used—for example cation exchange chromatography or by addition of a chelating agent such as ethylenediaminetetraacetic acid (EDTA).

The dilution step is another required condition for the aggregation of denatured proteins during heat treatment. At low protein concentrations, small aggregates are formed. At higher protein concentrations, the denatured proteins quickly form large aggregates or gels that could block the UF system during processing.

pH adjustment is another requirement for the heat treatment of the whey protein solution. At low ionic strength, high pH, and low protein concentration, heat treatment of whey protein solutions results in formation of low molecular weight (e.g. dimers & trimers) disulphide-linked protein aggregates (See FIG. 5). These aggregates have the tendency to be stable for a long period without forming a gel.

The heat treatment is required to be of sufficient duration to denature the majority of the whey proteins. Preferably the heat treatment is at least 70° C., more preferably at least 80° C. for up to 40 or 60 minutes. Heating may be carried out by a variety of methods including the use of a plate or tubular heat exchanger, scrape surface heat exchanger (SSHE), or by direct steam injection (DSI).

Heat treatment of the solution results in denaturation and aggregation of the whey proteins. Because the low protein concentration, the heat treatment results in aggregation process restricting to the formation of low molecular weight aggregates. The temperature/time combinations for the heat-treatment of whey protein solution can be varied to achieve varied degrees of protein denaturation. WPCs with different degree of protein denaturation offer different functional properties that can be used in a variety of food and industrial applications.

Following the heat treatment it is preferred to cool the heated solution down to 45-55° C. Once cooled, further water is removed, preferably by ultrafiltration. Preferably the retentate that results contains at least 10% total solids, more preferably at least 15% total solids, more preferably greater than 18% total solids, more preferably at least 20% total solids, most preferably at least 22% total solids. The concentrated solution may usefully be homogenised by standard methods. Whey drying may be carried out by conventional means, for example spray drying.

The evaporation or ultrafiltration step further increases the total solid concentration of the product stream. It is important that at all time the product is kept at around 50° C. This avoids the product forming a gel. At low temperatures, the retentate can quickly form a gel network. At higher temperatures retentates can also quickly form a gel network. The inventors of the current invention have found that at intermediate temperatures the gelation kinetics for the formation of whey gels are at a minimum.

The drying step is usually carried out after a dewatering step. This removes access water so that the final powder consists of around 3-4% moisture and ≧80% protein.

The applicant currently believes (without wishing to be bound by theory) that the key to this innovation is the provision of heating conditions that result in formation of specific protein aggregates (low molecular weight aggregates) that are stable for a period before formation of a gel network. This delay of gel formation allows the process (evaporation and drying) to be completed prior to gel formation. The conditions were combinations of low protein concentration, low ionic strength, and high pH.

The product typically has higher protein and fat, lower mineral and lactose than that of the standard WPC. The protein content is largely heat denatured (See Table 1, below). Fat can be removed by various means (e.g. microfiltration) if it is so desired.

Different levels of denaturation can be achieved by altering the heating temperature or time.

In another aspect, the invention provides a process comprising
(a) providing a whey protein concentrate comprising of about 10-30% (w/w) total solids, a combined calcium and magnesium concentration of less than 70 mmol/kg, w/w, preferably less than 60 mmol/kg, most preferably less than 50 mmol/kg, w/w, on a dry basis, and a pH of 6.5-7.5;
(b) heating using a scraped surface heat exchanger (SSHE) to a temperature of greater than 70° C. for up to 40 minutes to denature the whey protein;
(c) cooling the heated solution to 45-55° C.;
(d) spray drying to prepare a dried product.

This process allows removal of the dilution and secondary ultrafiltration step because SSHE allows use of a protein stream at higher protein concentrations and viscosities.

After cooling the cooled protein solution is optionally concentrated before spray drying. Prior to spray drying the cooled solution may be usefully homogenised.

The preferred conditions (for example of pH and temperature) described earlier are also preferred for this aspect of the invention where applicable.

A further aspect of the invention provides a product of a process of the invention.

The products of the invention have a wide range of utilities. These can be used in applications where it is desirable to increase viscosity and to increase protein content.

The invention consists in the foregoing and also envisages constructions of which the following gives examples only.

### BRIEF DESCRIPTION OF THE DRAWINGS

FIG. 1 is a flow chart of a process of the invention.

FIG. 2 is an example of a process of the invention starting from skim milk.

FIG. 3 is an alternative process for making denatured WPC where the heating step is done by a SSHE system, and effectively removing the dilution step, and the secondary UF step.

FIG. 4 is an example of the alternative process of the invention proposed in FIG. 3, starting from whole milk, a cheese process provided cheese whey for making the denatured WPC.

FIG. 5 is a typical native-PAGE of diluted retentate (2% protein) at either pH 7.0 (a) or 7.5 (b) heated for up to 30 min at 80° C. (I) or 95° C. (II). Note that the loss of native proteins (BSA, β-lactoglobulin (β-βLg), α-lactalbumin (α-la)), shown by the decreasing band intensity, resulted in formation of large quantities of low molecular weight aggregates, labelled “X”.

FIG. 6 shows viscosity of denatured WPC prepared from WPCDA80 (Example 2), 5% (a), 10% (b) and 15% (c) heat-denatured WPC solutions incubated at 5° C. for 1 h (, ◯), 5 h (▾, ∇), or 24 h (▪, □), as a function of shear rate. Shear rate increased from 0 to 1032 s⁻¹ (, ▾, ▪) and then decreased from 1032 s⁻¹ to 0 s⁻¹ (◯, ∇, □).

FIG. 7 shows viscosity changes of 10% heat-denatured WPC solutions (made using the process in FIG. 2) during 1 to 24 h incubation at 5° C. (), 20° C. (▾), or 40° C. (▪) measured at a shear rate of 15.15 s⁻¹.

### EXAMPLES

The following examples further illustrate practice of the invention.

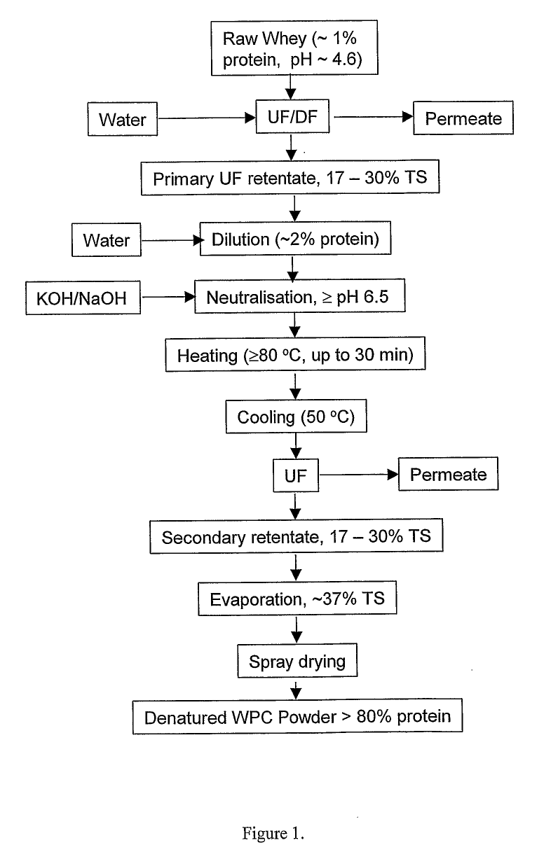

FIGS. 1-4 show in schematic form of the processes of the invention.

### Example 1

### Demonstration of the Formation of Low Molecular Weight Aggregates During Heating

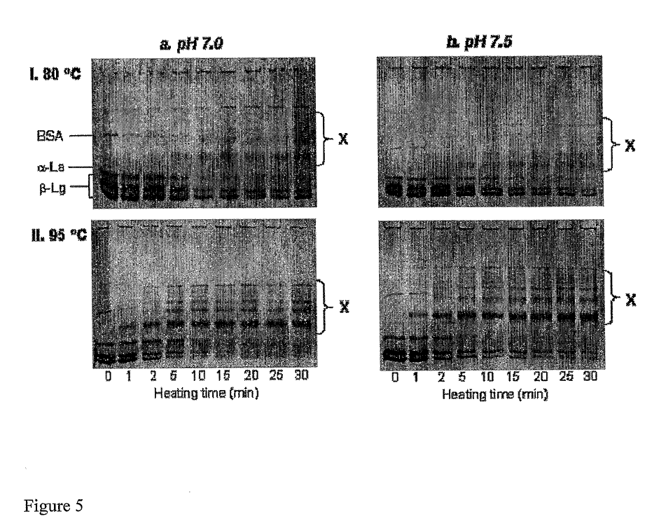

Raw whey having approximately 1% protein and a pH of approximately 4.6 was taken from an acid precipitation of casein from skim milk by addition of 10% sulphuric acid. It was ultrafiltered until the solid content was approximately 20% total solids. The retentate was diluted with purified water to provide a diluted retentate having 2% protein. The pH was adjusted using 10% KOH (w/v) to either 7.0 or 7.5. The pH adjusted diluted retentate was heated to 80° C. for 30 minutes. Samples were taken and subjected to native-PAGE (Havea, P., Singh, H., Creamer, L. K. & Campanella, O, H. Electrophoretic characterization of the protein products formed during heat treatment of whey protein concentrate solutions. Journal of Dairy Research, 65, 79-91, 1998). These results showed (FIG. 5) the quantities of β-lactoglobulin and α-lactalbumin decreased with heating time (indicated by the decreasing band intensities) accompanied by increasing quantities (band intensities) of low molecular weight aggregates labelled X.

### Example 2

### Demonstration of the Ability of the Invention to Provide WPCs with Different Levels of Protein Denaturation

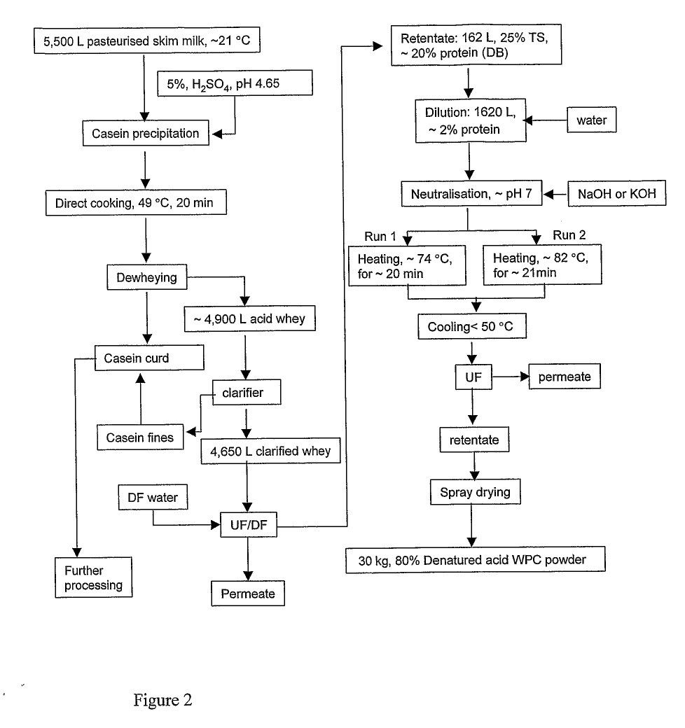

A process following that shown in FIG. 2 provided raw whey having approximately 1% protein and a pH of approximately 4.6 from an acid precipitation of casein from skim milk by addition of 5% sulphuric acid. After clarification, the whey was ultrafiltered until the solid content was approximately 20% total solids. The retentate was diluted with water to provide a diluted solution having 2% protein, and then the pH was adjusted using 10% (w/v) KOH to 6.9.

The diluted whey protein solution was separated into two streams and then heated at two different levels namely, run 1: 74° C. for 20 min, or run 2: 82° C. for 21 min. The heated whey streams were then cooled to 50° C. and ultrafiltered to provide secondary retentate lots containing ˜20% total solids. The retentate streams were then spray dried. The final powders were analysed and compared with standard unheated commercial acid WPC powder (control). The level of protein denaturation was estimated using Native Polyacrylamide gel electrophoresis (Native-PAGE) as described by Havea et al. (Havea, P., Singh, H., Creamer, L. K. & Campanella, O, H. Electrophoretic characterization of the protein products formed during heat treatment of whey protein concentrate solutions. Journal of Dairy Research, 65, 79-91, 1998). The combined intensities of the protein bands (β-lactoglobulin, α-lactalbumin, and BSA) in denatured whey protein solution (prepared from heat treated WPC powder) was compared to the combined band intensities of the same proteins in the unheated whey protein solution (prepared from unheated UF retentates).

TABLE 1
Comparison of the composition of the standard acid
WPC with the denatured WPC derived from the same
raw material using the process in FIG. 1.

| | | Run 1 | Run 2 |
|---|---|---|---|
| | | Denatured | Denatured |
| | Undenatured | WPC | WPC |
| Component | control WPC | WPCDA40 | WPCDA80 |
| Heat treatment | No heating | 74° C. for 20 | 82° C. for 21 |
| | | min | min |
| % protein | <1% | 40% | 81% |
| denaturation | | | |
| Fat (% w/w) | 4.57 | 6.01 | 6.11 |
| Protein (% w/w) | 79.94 | 86.00 | 86.45 |
| Lactose (% w/w) | 4.90 | 0.35 | 0.33 |
| Ash (% w/w) | 3.86 | 2.00 | 2.00 |
| Moisture (% w/w) | 4.63 | 3.56 | 3.77 |

Minerals

| | | | |
|---|---|---|---|
| Calcium (mg/kg) | 2600 | 1683 | 1810 |
| Potassium (mg/kg) | 12800 | 16730 | 17220 |
| Magnesium (mg/kg) | 161 | 108 | 110 |
| Sodium (mg/kg) | 1830 | 341 | 324 |

The denatured WPC products had different levels of protein denaturation, corresponding to different levels of heat treatment. These products generally had higher levels of protein and fat, lower levels of lactose and minerals compared to the standard acid WPC. This was due mainly to the higher degree of UF treatment used in making the denatured WPCs.

### Example 3

### Demonstration of the Importance of the Need to Keep the Heated retentate at 40 to 60° C.

Two buckets (1 L) of heated retentate (about 20% total solids) were obtained from Run 2 Example 2 above. One bucket was stored at 20° C., while the second was kept at 50° C. The protein solution in the bucket stored at 20° C. started to form considerably thick to strong gel within an hour. The protein solution was considered too thick for further processing, and was discarded. The protein retentate in the bucket that was kept at 50° C., remained a solution for more than three hours. This time delay would allow further processing of the solution under commercial conditions, before gel formation.

### Example 4

### Demonstration of the Importance of Low Protein Levels During Heating

A 5% WPC solution was prepared by reconstitution of a commercial acid WPC powder containing 80% protein (identical relative composition to the 2% solution of example 2). The solution contained about 4% protein (w/v) and about 70 mmol/kg calcium on a dry basis. It was heated at 75° C. for 20 min. The solution was the concentrated by ultrafiltration at 50° C. As the total solid total solid content of the retentate started to increase to about 7%, the pump pressure increased significantly quickly that the operator had to stop the trial. The UF membrane was shown to have significant fouling. This result demonstrated that heat treatment of whey solutions at protein concentrations of about 5% protein forms large protein aggregates that would foul and gel during a pre-drying concentration process. In contrast the solution heat treated at 2% protein from example 2 could be concentrated to 20% during pre-drying concentration processing.

### Example 5

### Demonstration of the Importance of Calcium Concentration

A whey protein solution comprising 3% protein and a calcium content of about 82 mmol/kg (dry basis) was prepared from cheese whey. The solution was heated at 78° C. for 20 min, and then concentrated by ultrafiltration. Like that shown in Example 4, the plant had to be closed down as fouling of the membrane caused significant pressure rises. In contrast the solution heat treated at 2% protein from example 2 and the 3% solution from example 6 which had 70 mmol calcium per kg solids could be concentrated to 20% during pre-drying concentration processing.

### Example 6

### Demonstration of the Use of Alternative Means of Heat Treatment

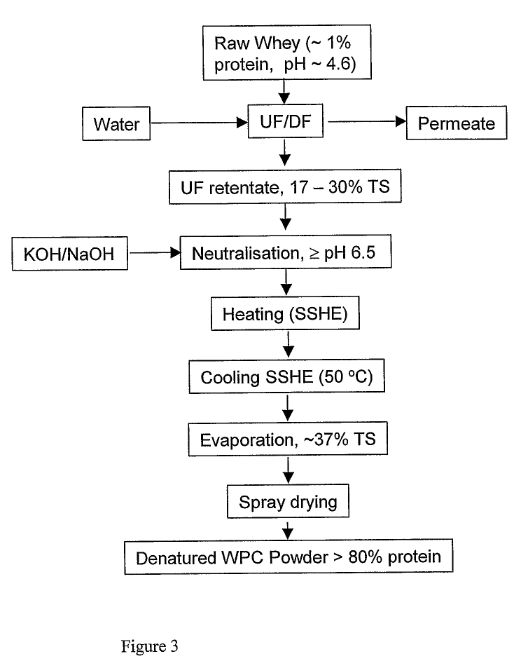

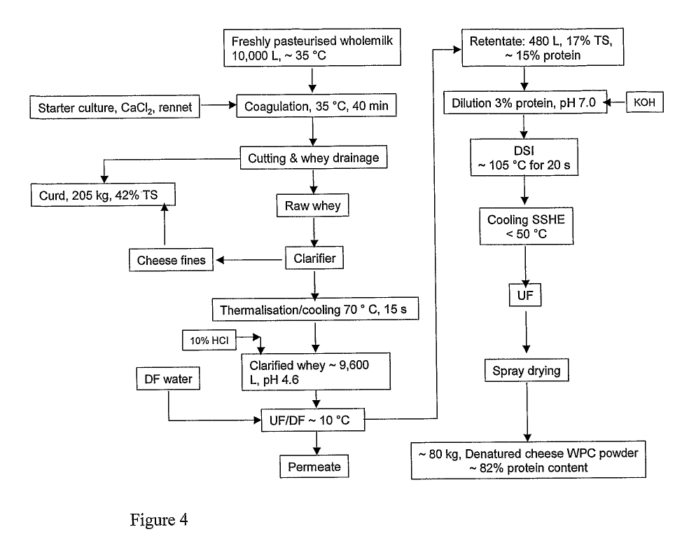

A whey protein powder was produced following the process proposed in FIG. 3, and described by FIG. 4. Freshly pasteurised whole milk was inoculated with cheese starter, in the presence of added CaCl₂ and rennet and then allowed to coagulate at 35° C. for about 40 min. The curd was then separated and the whey was clarified. The pH of the clarified whey was adjusted to 4.6, using 5% (w/v) sulphuric acid before ultra-filtration to obtain a retentate of about 15% protein. The solution was then diluted with water to obtain a 3% protein solution, and the pH adjusted to 7.0 using 10% KOH before heating (˜105° C. for 20 min) using a DSI. After heating, the solution was cooled to about 43° C. and then concentrate by ultrafiltration to a protein concentrate of 15%. The retentate was then spray dried.

The analysis of the product compared with that of a standard commercial cheese WPC is shown below (Table 2).

TABLE 2
Comparison of the composition of the standard cheese
WPC with the denatured WPC derived from the same
raw material using the process in FIG. 3 & 4.

| | | Denatured |
|---|---|---|
| | Standard cheese | WPC80 |
| Component | WPC80 | WPCDC60 |
| Heat treatment | No heating | 105° C. for 20 min |
| % protein denaturation | <1% | 59% |
| Fat (% w/w) | 6.14 | 6.8 |
| Protein (% w/w) | 82.13 | 83.41 |
| Lactose (% w/w) | 5.11 | 4.78 |
| Ash (% w/w) | 3.01 | 2.11 |
| Moisture (% w/w) | 3.78 | 3.67 |

Minerals

| | | |
|---|---|---|
| Calcium (mg/kg) | 3960 | 2058 |
| Potassium (mg/kg) | 7656 | 10720 |
| Magnesium (mg/kg) | 520 | 110 |
| Sodium (mg/kg) | 2025 | 1477 |

The denatured cheese WPC80 (WPCDC60) had calcium content of the levels defined in this invention and the product was capable of forming firm gels at room temperature (see examples below).

### Example 7

### Demonstration of the Cold Thickening Properties of the Denatured WPC Powders

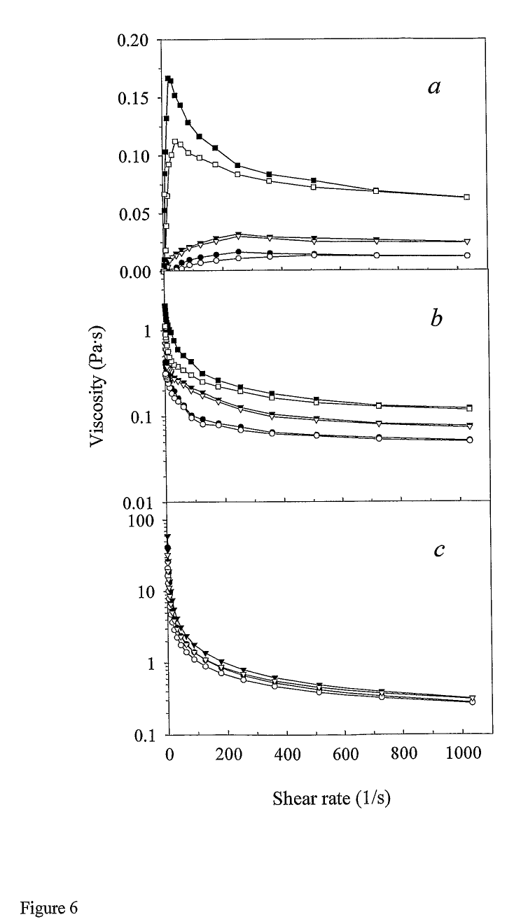

WPC solutions (5%, 10%, and 15%, w/w, pH 6.9) were prepared from WPCDA80 and then incubated at 5° C. for 1, 5, or 24 hours. The viscosity of each solution was measured using a PARR PHYSICA US200 rheometer in a cub and bob configuration at 5° C. The shear rate was increased from 0 to 1032 s⁻¹ (filled symbols) and then decreased from 1032 s⁻¹ to 0 s⁻¹ (unfilled symbols). The results are shown in FIG. 6. The viscosity of 5% and 10% solutions was strikingly increased by incubation at 5° C. from one hour to five hours and then from five hours to 24 hours at all shear rates. The results also demonstrate that the viscosity of the 15% WPC solution was many-fold that of the 10% or the 5% WPC solutions. The viscosity of a 15% WPC solution, prepared from standard acid WPC, that was stored under the same conditions had a viscosity that was compareble to that of the 5% denatured WPC solution. The WPC solutions of the same concentrations (5%, 10%, and 15%, pH 6.9) prepared from commercial undenatured acid WPC powder had relatively low viscosities (0.01-0.05) with minimal difference between them (results not shown).

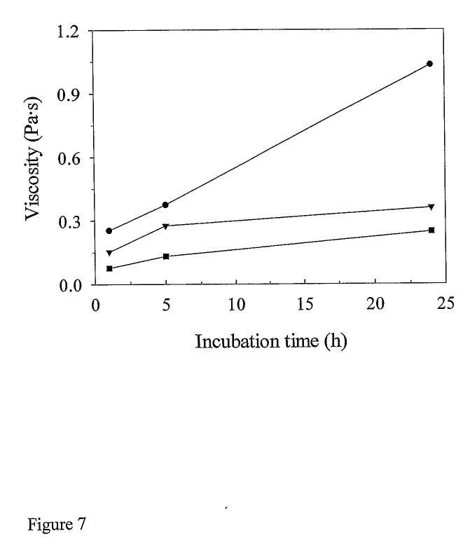

In a further experiment the viscosity changes of 10% WPC solutions prepared from WPCAD80, during 1-24 hour incubation at 5, 20, or 40° C. showed increases of viscosity with time and decrease in temperature (FIG. 7). The results demonstrated that denatured WPC can form highly viscous solutions at low temperature and may find many applications in the food industry.

### Example 8

### Demonstration of the Cold Gelling Ability of the WPC Powders

WPC solutions prepared from WPCDC60 (100 ml, 12% w/w, pH 7.0) were assessed for their ability to form gels at room temperature (˜20° C.) with addition of 10, 15, 20, or mM CaCl₂. The solutions were stored in beakers overnight at room temperature. In the next morning, the solutions had formed weak to firm gels and it was clear that the gel firmness increased with increasing levels of added CaCl₂.

The gels were then heated by immersing the beakers into a 95° C. thermally controlled water bath for 25 min. The gels did not melt on heating but became firmer with a ‘cooked egg white’ consistency.

These results demonstrated that the WPCD60 could form gels at room temperature with added CaCl₂. It also showed that the gels are heat stable and can be used in various applications in the food industry.

The term ‘comprising’ as used in this specification and claims means ‘consisting at least in part of’, that is to say when interpreting statements in this specification that include that term, the features, prefaced by that term in each statement, all need to be present but other features can also be present.

The above examples are illustrations of the practice of the invention. It will be appreciated by those skilled in the art that the invention can be carried out with numerous modifications and variations. For example the materials used the starting material may vary the processing times and temperatures may likewise be varied.

1. The process for preparing a modified whey protein concentrate comprising:
(a) providing a whey protein solution having less than 5% total solids and a combined calcium and magnesium concentration of less than 70 mmol/kg on a dry basis and a pH of 6.0-7.5;
(b) heat treating the solution obtained to greater than 70° C. for up to 60 minutes to denature the whey protein;
(c) cooling the heated solution to 40° C.-60° C.;
(d) spray drying to prepare a dried product.

2. A method as claimed in claim 1 wherein the whey protein solution in (a) has less than 3% total solids.

3. A method as claimed in claim 1 wherein the whey protein solution starting material is prepared by ultrafiltration of a whey protein concentrate comprising at least 10% (w/v) total solids.

4. A method as claimed in claim 3 wherein the whey protein solution is ultrafiltered at a pH in the range 4.0-6.0.

5. A method as claimed in claim 1 wherein the pH of the whey protein solution to be heated is in the range 6.5-7.3.

6. A method as claimed in claim 5 wherein the pH of the whey protein solution to be heated in the range 6.5-7.0.

7. A method as claimed in claim 1 wherein the combined calcium and magnesium concentration of the whey protein solution undergoing the heat treatment is less than 50 mmol/kg on a dry weight basis.

8. A method as claimed in claim 1 wherein following the heat treatment, the heated solution is cooled down to 45-55° C.

9. A method as claimed in claim 1 wherein following cooling, the cooled solution is concentrated to greater than 10% (w/v) as total solids.

10. A method as claimed in claim 9 wherein following cooling, the cooled solution is concentrated to greater than 18% (w/v) as total solids.

11. A method as claimed in claim 1 wherein cation exchange chromatography is used to prepare the whey starting material having a combined calcium and magnesium concentration of less than 70 mmol/kg on a dry basis.

12. A method for preparing a whey protein concentrate comprising:
(a) providing a whey protein concentrate comprising of about 10-30% (w/w) total solids, a combined calcium and magnesium concentration of less than 70 mmol/kg, on a dry basis, and a pH of 6.5-7.5;
(b) heating using a scraped surface heat exchanger (SSHE) to a temperature of greater than 70° C. for up to 60 minutes to denature the whey protein;
(c) cooling the heated solution to 40-60° C.

13. A method as claimed in claim 12 wherein the heated solution is cooled to 45-55° C.

14. A method for preparing a food product comprising a method of preparing a modified whey protein as claimed in claim 1 and using the product as an ingredient in the preparation of a food product.

15. A method as claimed in claim 14 wherein the product is selected from yoghurt, instant yoghurt, an ice-cream and instant dairy dessert.

16. A whey protein concentrate prepared by a method as claimed in claim 1.
